(19) United States
(12) Patent Application Publication
(10) Pub. No.: US 2025/0256421 A1
(43) Pub. Date: Aug. 14, 2025

(54) CUTTING PLOTTER

(71) Applicant: GRAPHTEC CORPORATION, Yokohama-shi (JP)

(72) Inventors: Yuzuru SEKIGUCHI, Yokohama-shi (JP); Takeya SHIBATA, Yokohama-shi (JP); Hidenobu SOMEYA, Yokohama-shi (JP)

(21) Appl. No.: 19/048,693

(22) Filed: Feb. 7, 2025

(30) Foreign Application Priority Data
Feb. 8, 2024 (JP) 2024-017748

(51) Int. Cl. B26D 7/26; B26F 1/38

(52) U.S. Cl. CPC B26D 7/2628; B26F 1/3813; B26D 2007/2678

(57) ABSTRACT

A cutting plotter (11) includes: a stage (13) configured to support a medium-to-be-cut (12); a pen carriage (16) configured to move above the stage; and a tool holder (21) supported by the pen carriage for holding a pen tool (19). The tool holder (21) includes: a supporting member (25) having a through hole (24); a sliding member (26) supported by the supporting member to be movable along a front-rear direction; and a pressing mechanism (45, 52, 36) configured to selectively bias the sliding member in either direction along the front-rear direction relative to the supporting member. The through hole (24) is formed in an oblong shape elongated in the front-rear direction as viewed from above. The sliding member (26) includes: a first pressing portion (46, 47) for pressing the pen tool against the front side (30) of the inner wall on the through hole (24); and a second pressing portion (48, 49) for pressing the pen tool against the other side, in the first bidirectional direction, of the inner wall on the through hole.

### TECHNICAL FIELD

The present invention relates to a cutting plotter configured to cut a sheet-like medium-to-be-cut by moving a cutting pen which has a cutter and which is held by a pen carriage in a two-dimensional direction relative to the medium-to-be-cut. In particular, the present invention relates to a cutting plotter that holds a pen tool, such as a cutting pen, at different positions on the pen carriage.

### BACKGROUND ART

Conventionally, a cutting plotter is known to cut a sheet-like medium-to-be-cut while moving a pen carriage having a cutting pen in a left-right direction while feeding the medium-to-be-cut back and forth on a stage. Among this type of cutting plotters, there is a cutting plotter capable of performing, if the medium-to-be-cut is an adhesive sheet to which an adhesive has been applied to a sheet-like base material, a half-cut for cutting only the sheet portion while leaving the release paper in the adhesive sheet, and a full-cut for completely cutting the medium-to-be-cut including the release paper. In such a cutting plotter, it is necessary to change the position at which the cutting pen is attached to the pen carriage when performing a half-cut and a full-cut.

The reason why the position at which the cutting pen is attached has to be changed is that the shape of the part of the stage supporting the medium-to-be-cut and the position at which the cutting is performed relative to the stage are different between the case where the half-cut is performed and the case where the full-cut is performed. That is, the half-cut is performed while supporting the medium-to-be-cut, and therefore it is performed on a surface formed on the stage, whereas the full-cut is performed over a groove formed on the stage so that the blade of the cutting pen can penetrate the medium-to-be-cut. The surface for the half-cut and the groove for the full-cut are provided spaced apart in the conveyance direction of the medium-to-be-cut.

There are also cutting plotters capable of drawing on the medium-to-be-cut by attaching a writing pen instead of a cutting pen. The writing pen is attached to a position where a cutting pen would be attached for performing a half-cut to enable drawing on the medium-to-be-cut. Hereinafter, the cutting pen and the writing pen are collectively referred to as a “pen tool.”

FIG. 17 shows an example of a pen carriage capable of changing the position to attach a cutting pen. In a cutting plotter having the pen carriage 1 shown in FIG. 17, the medium-to-be-cut (not shown) is conveyed from the lower left to the upper right direction in FIG. 17. Here, the conveyance direction of the medium-to-be-cut is referred to as a “first bidirectional direction”, the upstream, i.e., the lower left side of FIG. 17, is referred to as “front” of the cutting plotter, and the downstream, i.e., the upper right side of FIG. 17, is referred to as “rear” of the cutting plotter.

The pen carriage 1 shown in FIG. 17 supports a tool holder 3 for holding the cutting pen 2, movably in the up-down direction. The tool holder 3 includes: a main body 5 having a through hole 4 extending in the up-down direction, and a tool fastener 7 attached to the main body 5 by a screw member 6. The screw member 6 and the tool fastener 7 are provided at the front end of the main body 5. The screw member 6 has an external thread 6a (see FIG. 18) and is screwed onto the main body 5 while the external thread 6a is extending in the front-rear direction.

The tool fastener 7 moves rearward by screwing the screw member 6 into the main body 5 and moves forward by loosening the screw member 6.

Here, there are a front pen holding portion 8 and a rear pen holding portion 9 on the through hole 4. The front pen holding portion 8 and the rear pen holding portion 9 each have an opening having a substantially circular shape when viewed from above such that the cutting pen 2 can be inserted into each of the front pen holding portion 8 and the rear pen holding portion 9. In the through hole 4, parts of the two openings overlap each other to form an opening having a substantially figure “8” shape, and the through hole 4 is configured to not allow the cutting pen 2 inserted into the front pen holding portion 8 or the rear pen holding portion 9 to move in the front-rear or left-right direction.

The cutting pen 2 includes: a shaft portion 2a having a cylindrical shape and inserted into the front pen holding portion 8 and the rear pen holding portion 9 constituting a part of the through hole 4; and an annular flange 2b projecting to the outside in the radial direction from a part above the shaft portion 2a. The flange 2b is placed on a top surface of the main body 5 by inserting the shaft portion 2a into the front pen holding portion 8 or the rear pen holding portion 9. By placing the flange 2b on the top surface of the main body 5, the cutting pen 2 is held on the main body 5 without falling out of the tool holder 3. A writing pen (not shown) instead of the cutting pen 2 may be attached to the rear pen holding portion 9. A flange is also provided on the shaft portion of the writing pen similarly to the cutting pen 2.

The tool fastener 7 is a member for pressing the cutting pen 2, which is held by the front pen holding portion 8 or the rear pen holding portion 9, toward the rear so as to be fixed on the front pen holding portion 8 or the rear pen holding portion 9. As shown in FIGS. 17-19, the tool fastener 7 has a pair of upper and lower protrusions 7a and 7b.

When attaching the cutting pen 2 to the front pen holding portion 8, the cutting pen 2 is inserted into the front pen holding portion 8 with the screw member 6 being loosened and the tool fastener 7 being moved relatively forward as shown in FIG. 18. FIG. 18 depicts this situation with the interior of the cutting pen 2 omitted. In this case, the cutting pen 2 is inserted into the front pen holding portion 8 while the screw member 6 is loosened to the extent that it does not come off the main body 5, and then the screw member 6 is screwed onto the main body 5. By thus screwing the screw member 6 into the main body 5, the upper and lower protrusions 7a and 7b of the tool fastener 7 push the cutting pen 2 from front to rear such that the cutting pen 2 is fixed in the front pen holding portion 8.

The upper protrusion 7b contacts the flange 2b of the cutting pen 2 from above and the flange 2b is sandwiched by the upper protrusion 7b and the main body 5 such that the upward movement of the cutting pen 2 is restricted.

When attaching the cutting pen 2 to the rear pen holding portion 9, the screw member 6 is screwed onto the main body 5 until the tool fastener 7 reaches the cutting pen 2, with the cutting pen 2 being inserted into the rear pen holding portion 9, as shown in FIG. 19. Then, the upper and lower protrusions 7a and 7b of the tool fastener 7 push the cutting pen 2 such that the cutting pen 2 is pressed against the rear pen holding portion 9 for fixation. In this case as well, the upper protrusion 7a overlaps the flange 2b from above and restricts the upward movement of the cutting pen 2.

### SUMMARY OF THE INVENTION

In the tool holder 3 shown in FIGS. 17-19, when performing a half-cut to cut only an upper layer of the medium-to-be-cut after performing a full-cut that completely cuts through the entire thickness of the medium-to-be-cut, it is necessary to pull out the cutting pen 2, for example, upward from the front pen holding portion 8, and reinsert the cutting pen 2 into the rear pen holding portion 9 after performing the full-cut. Therefore, when switching between a full-cut mode and a half-cut mode, the cutting pen 2 must be removed and inserted every time, which is troublesome.

The present invention aims to provide a cutting plotter that can selectively use two pen holding portions on different locations without the need for removing and inserting the cutting pen.

In order to achieve this objective, a cutting plotter in accordance with an embodiment of the present invention comprises:
a stage configured to support a medium-to-be-cut;
a conveyance mechanism configured to convey a medium-to-be-cut placed on the stage along a surface of the stage in a first bidirectional direction;
a guide rail which is spaced apart from the surface of the stage and which extends in a second bidirectional direction parallel to the surface of the stage and intersecting with the first bidirectional direction;
a pen carriage configured to move along the guide rail above the stage; and
a tool holder which is supported by the pen carriage movable in a third bidirectional direction perpendicular to the first bidirectional direction and the second bidirectional direction and which holds a pen tool in a posture in which the pen tool extends in the third bidirectional direction, wherein the tool holder comprises:
a supporting member having a through hole into which the pen tool is to be inserted;
a sliding member supported by the supporting member movably along the first bidirectional direction; and
a pressing mechanism configured to selectively bias the sliding member in either direction along the first bidirectional direction relative to the supporting member,
the through hole has an oblong shape extending longer along the first bidirectional direction when viewed from the third bidirectional direction such that the pen tool is movable in the through hole from one end to the other along the first bidirectional direction, and
the sliding member comprises:
a first pressing portion for pressing the pen tool onto one side, in the first bidirectional direction, of an inner wall on the through hole by moving the pen tool in one direction along the first bidirectional direction relative to the supporting member; and
a second pressing portion for pressing the pen tool onto the other side, in the first bidirectional direction, of the inner wall on the through hole by moving the pen tool in the other direction along the first bidirectional direction relative to the supporting member.

In accordance with the present invention, the pen tool can move parallel along the first bidirectional direction in the through hole formed on the supporting member of the tool holder so as to be fixed onto either one side or the other side of the inner wall on the through hole in the first bidirectional direction. Therefore, in accordance with the present invention, it is possible to provide a cutting plotter that can selectively use pen holding portions on two locations without removing and inserting the cutting pen.

### BRIEF DESCRIPTION OF THE DRAWINGS

FIG. 1 shows a perspective view schematically illustrating a structure of a cutting plotter according to the present invention.

FIG. 2 shows a cross-sectional view for explaining the shape of a stage.

FIG. 3 shows a perspective view of a pen carriage.

FIG. 4 shows an exploded perspective view of a tool holder.

FIG. 5 shows a plan view illustrating a part of the tool holder.

FIG. 6 shows a perspective view of a supporting member and the cutting pen as viewed obliquely from above.

FIG. 7 shows a perspective view of the supporting member as viewed obliquely from below.

FIG. 8 shows a plan view of a sliding member.

FIG. 9 shows a cross-sectional view of a connection between the supporting member and a pressing mechanism in a transversal direction as viewed from the front.

FIG. 10 shows a cross-sectional view of the tool holder in the longitudinal direction.

FIG. 11 shows a cross-sectional view of the tool holder in a longitudinal direction.

FIG. 12A shows a front view of the presser as viewed from the supporting member side.

FIG. 12B shows a plan view illustrating the presser.

FIG. 12C shows a side view illustrating the presser.

FIG. 12D shows a perspective view illustrating the presser.

FIG. 13 shows a cross-sectional view of the tool holder in the transversal direction.

FIG. 14 shows a perspective cross-sectional view illustrating the tool holder wherein a cross section is taken along a part of the tool holder.

FIG. 15 shows a perspective view of the tool holder with the slider being moved to the front.

FIG. 16 shows a perspective view of the tool holder with the slider being moved to the rear.

FIG. 17 shows a perspective view of a conventional pen carriage.

FIG. 18 shows a cross-sectional view of a conventional tool holder and cutting pen.

FIG. 19 shows a cross-sectional view of a conventional tool holder and cutting pen.

### DETAILED DESCRIPTION OF THE INVENTION

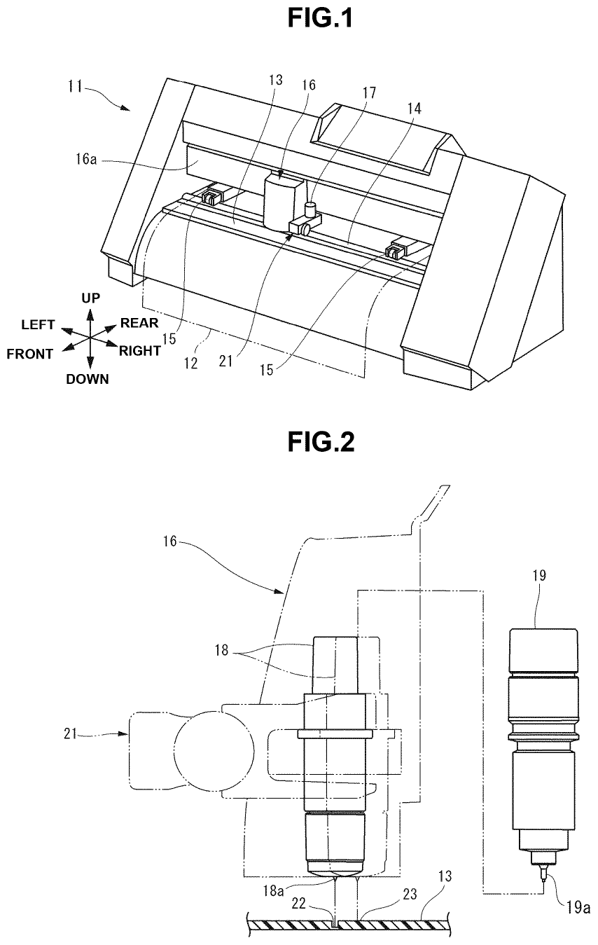

Hereinafter, an embodiment of the cutting plotter according to the present invention will be described in detail with reference to FIGS. 1-16.

The cutting plotter 11 shown in FIG. 1 includes: a stage 13 configured to support a sheet 12, which is a medium-to-be-cut; a conveyance mechanism configured to convey the medium-to-be-cut placed on the stage 13 along a front-rear direction (first bidirectional direction) along a surface of the stage 13; a guide rail 16a which is spaced apart from the surface of the stage 13 and which extends in a left-right direction (second bidirectional direction) parallel to the surface of the stage 13 and intersecting the front-rear direction; a pen carriage 16 configured to move along the guide rail 16a above the stage 13; and a tool holder 21 which is supported by the pen carriage 16 movable in an up-down direction (third bidirectional direction) and which holds the pen tool 17 in a posture in which the pen tool 17 extends in the up-down direction.

In the cutting plotter 11 shown in FIG. 1, the sheet 12 is placed on the stage 13 forming a conveyance path so as to be transported from the upper right side to the lower left side or from the upper left side to the lower right side in FIG. 1 while the sheet 12 is sandwiched between a drive roller 14 and a push roller 15, which constitute a conveyance mechanism. The cutting plotter 11 performs a full-cut, a half-cut, drawing, etc. on the sheet 12 by raising and lowering the pen tool 17 in the up-down direction while conveying the sheet 12 in the front-rear direction and moving the pen carriage 16 in the left-right direction.

The pen carriage 16 is movably supported on guide rail 16a arranged above the stage 13 such that the pen carriage 16 can move in the left-right direction (from the upper left to the lower right in FIG. 1) perpendicular to the conveyance direction of the sheet 12. Hereinafter, when referring to an orientation of a part, the downstream of the sheet 12 in the conveyance direction (the lower left side in FIG. 1) is referred to as the “front” of the cutting plotter 11. FIG. 1 shows a view of the cutting plotter 11 as viewed from the front.

A tool holder 21 is attached to the pen carriage 16 such that the tool holder 21 can be raised or lowered. The pen carriage 16 includes a driving device, such as a solenoid (not shown), for raising and lowering the tool holder 21. The tool holder 21 is connected to the driving device installed inside the pen carriage 16 and moves by the driving device in the up-down direction.

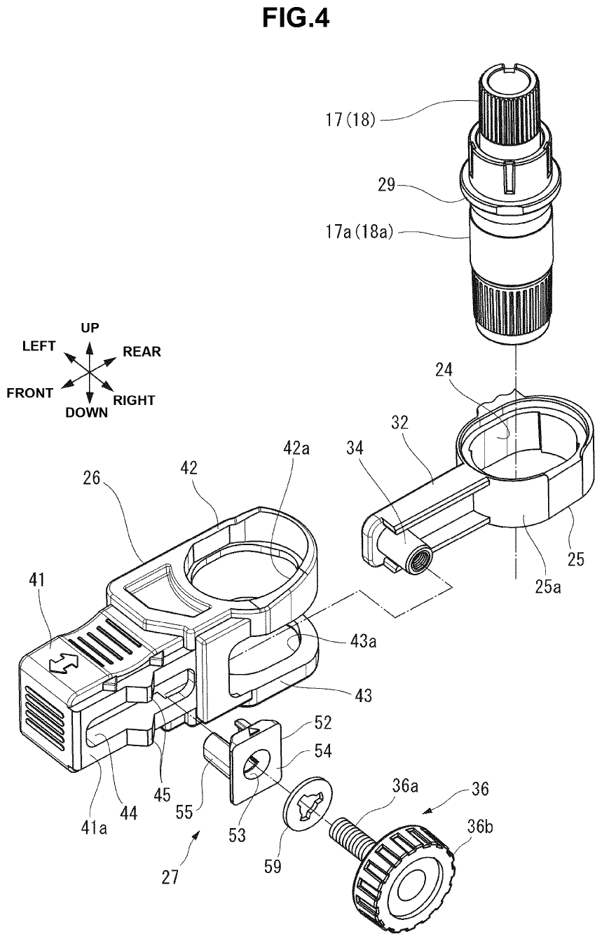

As shown in FIG. 2, the tool holder 21 holds a cutting pen 18 used for a full-cut and a half-cut, a writing pen 19 used for drawing, etc. in a posture in which they extend in the up-down direction. Here, there is a protruding blade 18a on a lower end of the cutting pen 18. In addition, there is a writing device body 19a on a lower end of the writing pen 19. As shown in FIG. 4, the cutting pen 18 and the writing pen 19 respectively include: a cylindrical shaft portion 17a, 18a which is to be inserted into the tool holder 21; and an annular flange 29 projecting radially outwards from a part above the shaft portion 17a, 18a. Hereinafter, the cutting pen 18 and writing pen 19 may be collectively referred to as a “pen tool 17”.

As shown in FIG. 2, on the stage 13, there are a first pen receiving portion 22 for a full-cut, and a second pen receiving portion 23 for a half-cut or writing, spaced apart in the front-rear direction. The first pen receiving portion 22 is constituted by a groove that extends in the horizontal direction (left-right direction), which is perpendicular to the conveyance direction of the sheet 12. The second pen receiving portion 23 is constituted by a flat surface extending in the left-right direction.

As described below, the tool holder 21 attached to the pen carriage 16 is configured to be able to hold the pen tool 17 respectively above the first pen receiving portion 22 and above the second pen receiving portion 23. The pen tool 17 held in the tool holder 21 is raised and lowered between a cutting/drawing position on a lower level and a retracted position on an upper level by moving the tool holder 21 with a driving device. By lowering the cutting pen 18 or the writing pen 19 to a position corresponding to the first pen receiving portion 22 for the full-cut and the second pen receiving portion 23 for the half-cut/writing, formed on the stage 13, it becomes possible to perform a full-cut, a half-cut, drawing, etc.

### Tool Holder

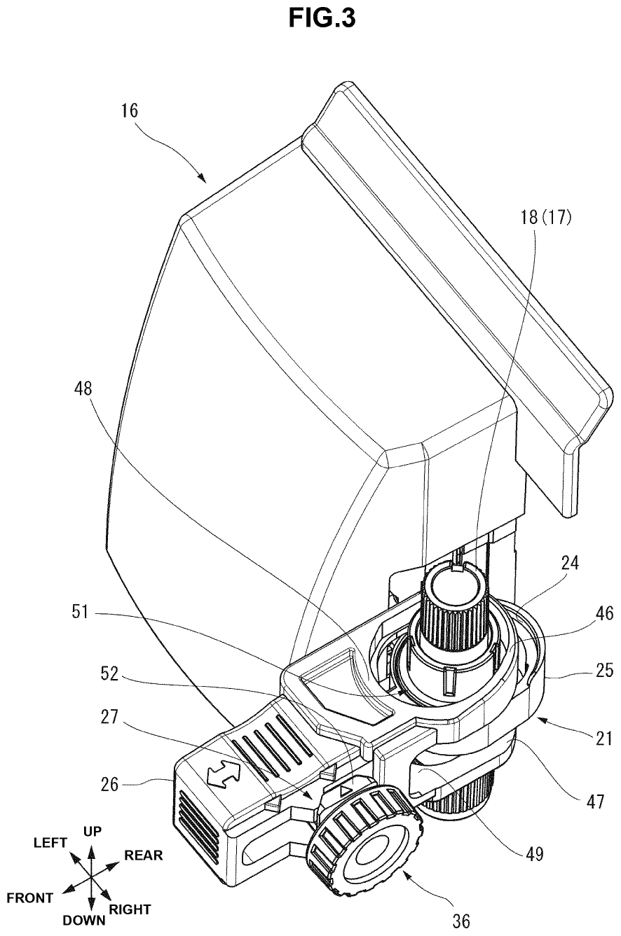

As shown in FIGS. 3 and 4, in the cutting plotter 11 according to this embodiment, the tool holder 21 includes: a supporting member 25 having a through hole 24 into which the pen tool 17 is to be inserted; a sliding member 26 supported by the supporting member 25 movably along the front-rear direction (conveyance direction of the sheet 12); and a pressing mechanism 27 configured to selectively bias the sliding member 26 in either direction along the front-rear direction, i.e., forward or rearward, relative to the supporting member 25.

### Supporting Member

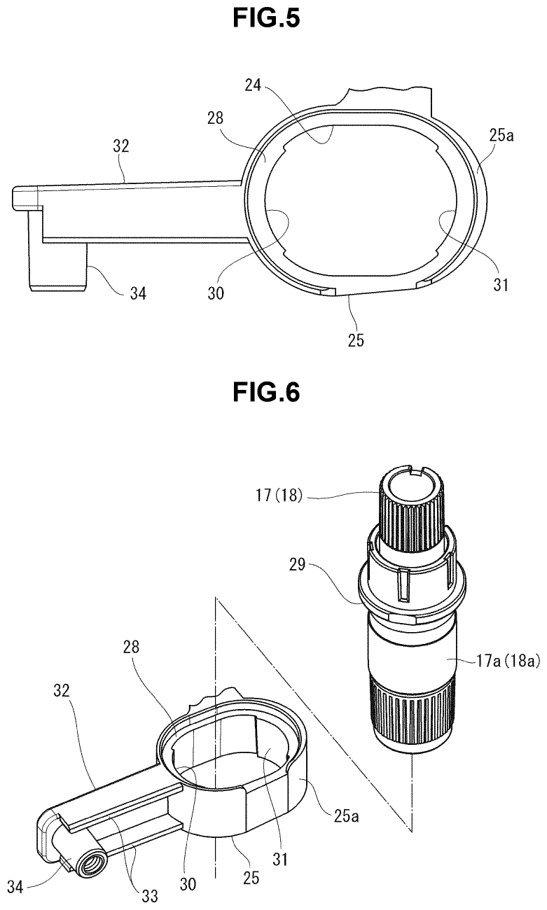

Here, the supporting member 25 includes a tubular body 25a defining the through hole 24 as shown in FIG. 4. Although not shown in the drawings, a driving device is connected to the left end of the tubular body 25a via a connecting arm. As shown in FIG. 5, the through hole 24, when viewed from above, is elliptically elongated in the front-rear direction, allowing the pen tool 17 inserted into the through hole 24 to move from a front end (one end, which is a downstream end, of the sheet 12 in the conveyance direction) to a rear end (the other end, which is an upstream end, of the sheet 12 in the conveyance direction) in the through hole 24. Such a supporting member 25 can be formed using resin, or metal such as aluminum.

As shown in FIG. 6, a recessed portion 28 is formed on the entire circumference of the opening on the through hole 24, on the upper side of the supporting member 25, more specifically, on the peripheral edge of the opening on the through hole 24 on the top surface of the tubular body 25a, such that the width is partially wider on the opening. A flange 29 formed on the outer circumference of the pen tool 17 is placed on the recessed portion 28. The flange 29 is formed over the entire outer circumference of the pen tool 17 such that the outer diameter is partially larger on the flange 29. The depth of the recessed portion 28 is shallower than the thickness (length formed in the up-down direction) of the flange 29. Therefore, when the flange 29 is placed on the recessed portion 28, the upper end surface of the flange 29 is positioned above the top surface of the tubular body 25a.

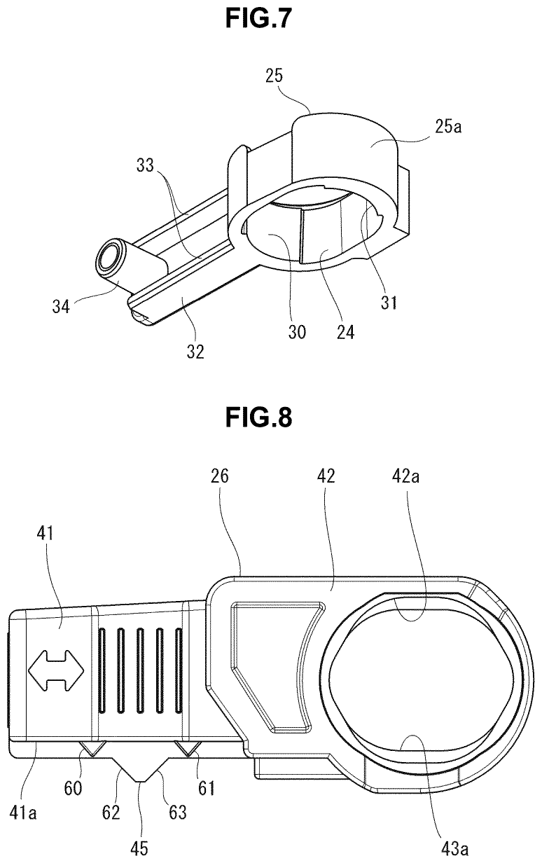

A front inner wall surface 30 (see FIG. 7) on the front end of the tubular body 25a, and the rear inner wall surface 31 on the rear end of the tubular body 25a, on the inner wall surface of through hole 24, are shaped to fit thereon the shaft portion 17a (18a) formed in a cylindrical shape under the flange 29 of the pen tool 17 (cutting pen 18). By sliding the pen tool 17 forward while the flange 29 is placed on the recessed portion 28, the shaft portion 17a of the pen tool 17 comes in close contact with the front inner wall surface 30. Meanwhile, by sliding the pen tool 17 rearward while the flange 29 is placed on the recessed portion 28, the shaft portion 17a comes in close contact with the rear inner wall surface 31.

In this embodiment, the shapes of the front inner wall surface 30 and the rear inner wall surface 31 on the through hole 24 are described as following the cylindrical side surface of the shaft portion 17a of the pen tool 17. However, as long as the position of the pen tool 17 is fixed in the front-rear direction, the shapes of the front inner wall surface 30 and the rear inner wall surface 31 do not necessarily need to follow the shaft portion 17a of the pen tool 17 and can, for example, be formed in a V-shape when viewed from above.

As shown in FIGS. 4-6, a supporting bracket 32 extending forward from the front end of the tubular body 25a is formed integrally with the supporting member 25. The supporting bracket 32 is for supporting the sliding member 26 described later. In this embodiment, the supporting bracket 32 includes a pair of upper and lower guide members 33, 33 and a screw-fixing boss 34, as shown in FIG. 6.

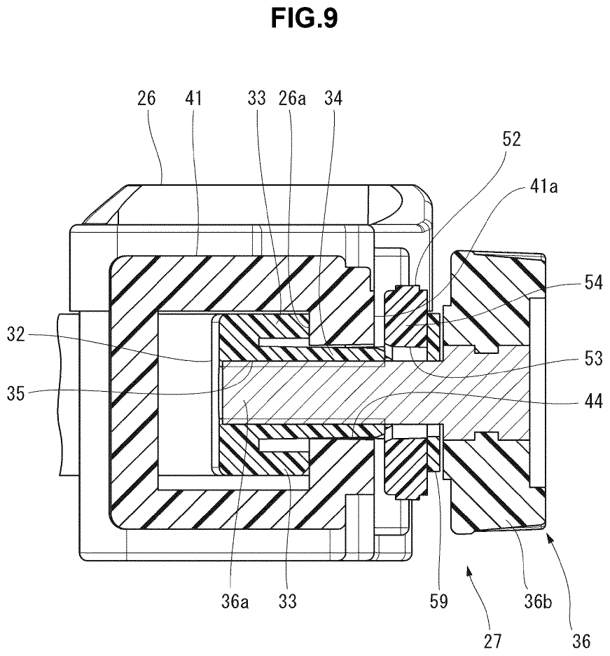

Here, as shown in FIG. 9, the pair of guide members 33 contact the inner side surface 26a of the sliding member 26 so as to regulate the moving direction of the sliding member 26 in the front-rear direction. FIG. 9 shows a cross section taken along line IX-IX in FIG. 13.

The screw-fixing boss 34 is formed in a cylindrical shape at the front end of the supporting bracket 32 and protrudes to the right from the front end of the supporting bracket 32. An internal thread 35 is formed on the shaft center portion of the screw-fixing boss 34. The screw-fixing boss 34 is for connecting the pressing mechanism 27 described later. A screw member 36 (see FIG. 4) of the pressing mechanism 27 described later is screwed onto the internal thread 35.

### Sliding Member

As shown in FIG. 4, the sliding member 26 includes: a main body 41 which constitutes a front half of the sliding member 26; and an upper pressing fragment 42 and a lower pressing fragment 43 extending rearward from the rear end of the main body 41. The main body 41 is formed in a bottom-solid prismatic shape opening to the rear. The supporting bracket 32 of the supporting member 25 is inserted from the rear into the main body 41. An elongate hole 44 elongated in the front-rear direction is formed on the right side wall 41a of the main body 41. A pair of upper and lower protrusions 45 projecting to the right are formed on the side wall 41a on the right side of the main body 41. Such a sliding member 26 may, for example, be formed by injection molding of resin.

In this embodiment, the upper pressing fragment 42 and the lower pressing fragment 43 of the sliding member 26 are arranged on the upper and lower sides of the supporting member 25, respectively. The rear end 46 of the upper pressing fragment 42 and the rear end 47 of the lower pressing fragment 43 of the sliding member 26 act as a first pressing portion, which presses the pen tool 19 against the front inner wall surface 30 on the through hole 24, as a result of the sliding member 26 moving in the forward direction (one direction along the front-rear direction) relative to the supporting member 25. The front end 48 of the upper pressing fragment 42 and the front end 49 of the lower pressing fragment 43 act as a second pressing portion, which presses the pen tool 19 against the rear inner wall surface 31 on the through hole 24, as a result of the sliding member 26 moving in the rearward direction (the opposite direction along the front-rear direction) relative to the supporting member 25.

The elongate hole 44 is formed to penetrate the right side wall 41a of the main body 41 in the left-right direction. As shown in FIG. 9, the screw-fixing boss 34 of the supporting bracket 32 is inserted into the elongate hole 44. The guide member 33 of the supporting bracket 32 is pressed against the right side wall 41a (inner side surface 26a) inside the main body 41 by the screw-fixing boss 34 being drawn to the right by the pressing mechanism 27 described later, and the right side wall 41a of the main body 41 becomes parallel to the guide member 33. The sliding member 26 is assembled to the supporting member 25 while the sliding member 26 is in parallel to the guide member 33 (while extending in the front-rear direction).

As shown in FIG. 4, the upper pressing fragment 42 and the lower pressing fragment 43 are formed in a frame-like shape, each having a substantially elongate hole 42a, 43a elongated in the front-rear direction when viewed from above. As shown in FIG. 8, the opening on the holes 42a, 43a is formed in the same shape as the through hole 24 of the supporting member 25 such that the pen tool 17 can be inserted from above and the inserted pen tool 17 can move from the front end to the rear end of the holes 42a, 43a. The opening width of the holes 42a, 43a is larger than the outer diameter of the flange 29 of the pen tool 17.

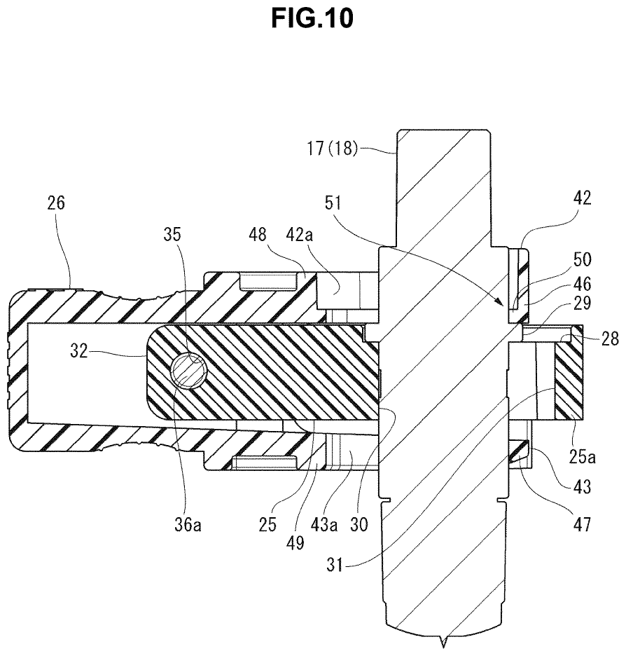

As shown in FIG. 10, the upper pressing fragment 42 is positioned above the tubular body 25a of the supporting member 25 while the sliding member 26 is assembled to the supporting member 25. The interior of the pen tool 17 is omitted in FIGS. 10, 11, and 13. FIG. 10 shows a cross section taken along X-X line in FIG. 13.

The lower pressing fragment 43 is positioned below the tubular body 25a of the supporting member 25 while the sliding member 26 is assembled to the supporting member 25.

The upper pressing fragment 42 and the lower pressing fragment 43 cause the holes 42a, 43a to overlap the through hole 24 of the supporting member 25 when viewed from above by moving the sliding member 26 in the front-rear direction relative to the supporting member 25. In this way, the pen tool 17 is inserted from above while the holes 42a, 43a and the through hole 24 overlap.

When the pen tool 17 is inserted in this way, the flange 29 of the pen tool 17 is placed on the recessed portion 28 on the supporting member 25. Then, when the sliding member 26 is moved forward from this situation, the rear ends 46 and 47 of the upper pressing fragment 42 and the lower pressing fragment 43 come into contact with the pen tool 17 to push the pen tool 17 forward, as shown in FIG. 10. The pen tool 17 thus pushed forward is pressed against the front inner wall surface 30 of the supporting member 25. Hereinafter, the position of the pen tool 17 thus pressed against the front inner wall surface 30 will be referred to as a “first position.” The first position is located above the first pen receiving portion 22 described above.

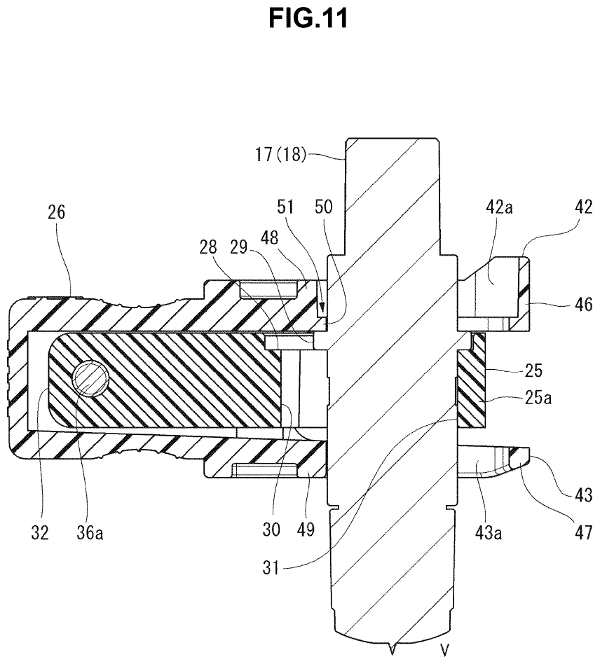

Meanwhile, when the sliding member 26 is moved rearward while the flange 29 of the pen tool 17 is placed on the recessed portion 28 on the supporting member 25, the front ends 48 and 49 of the upper pressing fragment 42 and the lower pressing fragment 43 come into contact with the pen tool 17 to push the pen tool 17 rearward, as shown in FIG. 11. The pen tool 17 thus pushed rearward is pressed against the rear inner wall surface 31 of the supporting member 25. Hereinafter, the position of the pen tool 17 thus pressed against the rear inner wall surface 31 will be referred to as a “second position.” The second position is located above the second pen receiving portion 23 described above.

### Pressing Mechanism

As shown in FIGS. 3 and 4, the pressing mechanism 27 includes: a protrusion 45 formed on the right side wall 41a on the main body 41 of the sliding member 26; a presser 52 arranged to face the right side wall 41a on the main body 41 of the sliding member 26; and a screw member 36 for attaching the presser 52 to the supporting member 25.

As shown in FIG. 8, the protrusion 45 on the side wall 41a of the sliding member 26 is formed in a triangular shape, and convex to the right when viewed from above. The protrusion 45 forms: a front pressure receiving surface 62 constituted by an inclined surface inclined relative to the axis of the screw member 36 in the front-rear direction; and a rear pressure receiving surface 63 constituted by an inclined surface located rearward.

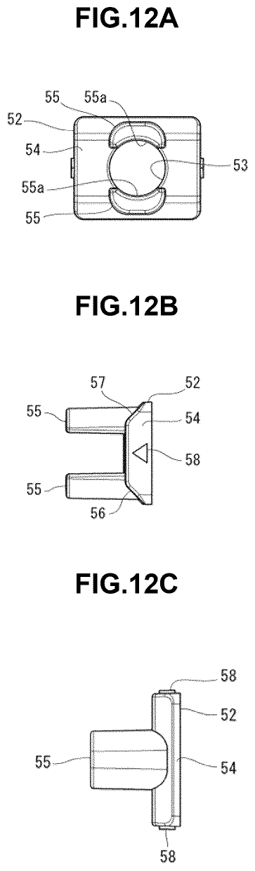

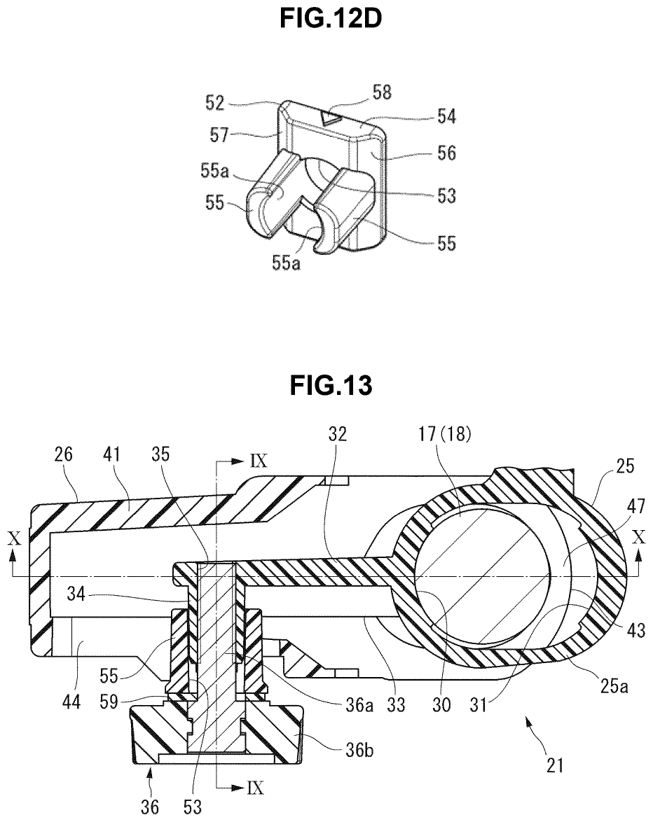

Meanwhile, as shown in FIGS. 12A-12D, the presser 52 is constituted by: a plate-like pressing member 54 on which a circular through hole 53 is formed in the center; and a pair of arms 55 protruding from the pressing member 54.

Among these components, as shown in FIG. 12B, the pressing member 54 is formed in a trapezoidal shape when viewed from above. As shown in FIG. 9, the width of the pressing member 54 formed in the up-down direction is such that it covers the right side wall 41a of the sliding member 26 (main body 41) from the right side. The planar shape of the pressing member 54 is trapezoid and the pressing member 54 is used with a shorter parallel side of the trapezoid facing the side wall 41a of the sliding member 26. That is, the front pressing surface 56 and the rear pressing surface 57 constituted by inclining surfaces inclined in the front-rear direction relative to the axis of the screw member 36, are respectively formed on the front and rear ends of the pressing member 54. The front pressing surface 56 and the rear pressing surface 57 are inclined such that the thickness of the pressing member 54 gradually decreases towards the right side from the left end (the end facing the side wall 41a) of the pressing member 54.

The protrusion 45 on sliding member 26 having the aforementioned front pressure receiving surface 62 and rear pressure receiving surface 63, and the presser 52 having the front pressing surface 56 and rear pressing surface 57 form a cam that converts the pressing force applied from the presser 52 to the front pressure receiving surface 62 or the rear pressure receiving surface 63 of the protrusion 45 by the screw member 36 into a driving force that moves the sliding member 26 in the front-rear direction.

On the upper and lower end surfaces of the pressing member 54, marks 58 are formed to serve as guides for positioning the sliding member 26 when moving the sliding member 26 in the front-rear direction.

The through hole 53 on the pressing member 54 is a hole for passing a bolt 36a of the screw member 36 (see FIG. 9). As shown in FIGS. 9 and 13, the screw member 36 is constituted by a bolt 36a and a disk-shaped knob 36b. A washer 59 is disposed between the knob 36b and the pressing member 54. The diameter of the through hole 53 is such that the screw-fixing boss 34 of the supporting member 25 can be fit into the through hole 53.

The arm 55 extends to the left from the central portion of the pressing member 54 in the up-down direction. As shown in FIG. 14, the width of the arm 55 in the up-down direction is such that the arm 55 can be inserted into the elongate hole 44 of the sliding member 26. A recessed portion 55a (see FIG. 12D) having a shape resembling an extension of the through hole 53 of the pressing member 54 is formed on the arm 55. The recessed portion 55a fits onto the screw-fixing boss 34 with the arm 55 being inserted into the elongate hole 44 of the sliding member 26.

The presser 52 is attached to the screw-fixing boss 34 by the screw member 36 with the arm 55 being inserted into the elongate hole 44 of the sliding member 26 and being fit onto the screw-fixing boss 34. When tightening or loosening the screw member 36, the presser 52 does not rotate since the arm 55 abuts the inner wall surface on the elongate hole 44. Tightening the screw member 36 is carried out with the protrusion 45 on the side wall on the sliding member 26 aligned with the presser 52 in the front-rear direction.

The front mark 60 and the rear mark 61 are provided in the vicinity to the protrusion 45 on the upper end of the side wall 41a. The front mark 60 serves as a guide for positioning the sliding member 26 when attaching the pen tool 17 on the second position. The rear mark 61 serves as a guide for positioning the sliding member 26 when attaching the pen tool 17 on the first position. When moving the sliding member 26 in the front-rear direction, the sliding member 26 is positioned such that the front mark 60 or the rear mark 61 aligns with the mark 58 on the presser 52 in the left-right direction.

The front pressure receiving surface 62 and the rear pressure receiving surface 63 are formed to face the front pressing surface 56 and the rear pressing surface 57 of the presser 52, respectively, and cooperate with the presser 52 to form the cam 64 that changes the transmission direction of the force.

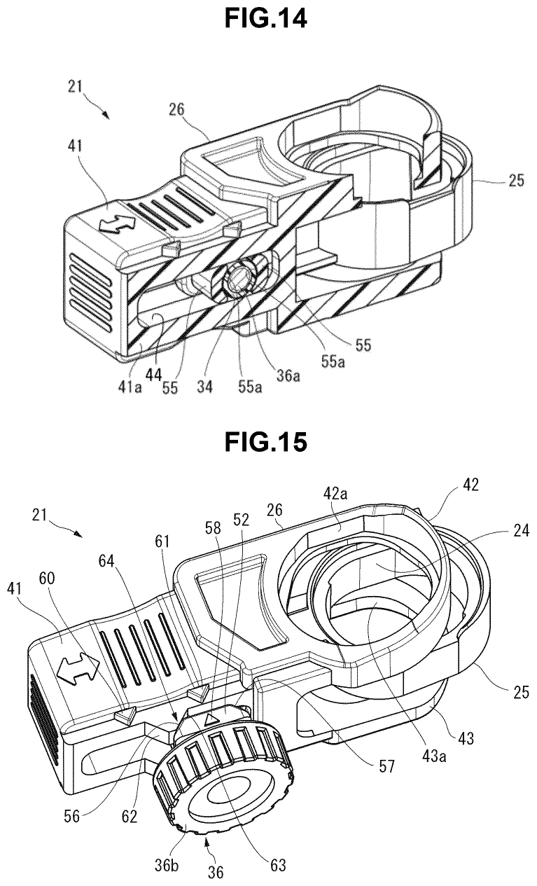

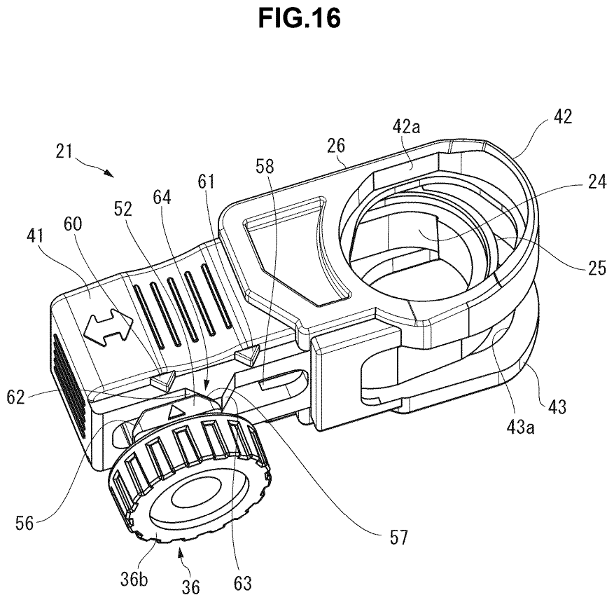

That is, as shown in FIG. 15, by tightening the screw member 36 while the front pressure surface 56 of the presser 52 is in contact with the rear pressure receiving surface 63 of the protrusion 45, the pressing force applied from the presser 52 to the rear pressure receiving surface 63 is converted into a driving force that moves the sliding member 26 forward such that the sliding member 26 is biased forward as a result of the driving force. Accordingly, by moving the sliding member 26 forward with the aforementioned movement of the cam 64 while the pen tool 17 is inserted into and held by the holes 42a, 43a on the sliding member 26 and the through hole 24 on the supporting member 25, the pen tool 17 is pushed to the front and pressed against the front inner wall surface 30 by the upper pressing fragment 42 and the lower pressing fragment 43 so as to be fixed onto the supporting member 25, as shown in FIG. 10.

Meanwhile, as shown in FIG. 16, by tightening the screw member 36 while the rear pressing surface 57 on the presser 52 is in contact with the front pressure receiving surface 62 on the protrusion 45, the pressing force applied from the presser 52 to the front pressure receiving surface 62 is converted into a driving force that moves the sliding member 26 to the rear such that the sliding member 26 is biased to the rear by the driving force. When the sliding member 26 moves to the rear as a result of the aforementioned movement of the cam 64 while the pen tool 17 is inserted into and held by the holes 42a, 43a of the sliding member 26 and the through hole 24 of the supporting member 25, the pen tool 17 is pressed to the rear inner wall surface 31 by the upper pressing fragment 42 and the lower pressing fragment 43 and is fixed to the supporting member 25, as shown in FIG. 11.

Therefore, when switching between a full cut mode (in which the cutting pen 18 is positioned at the first position) and a half cut mode (in which the cutting pen 18 is positioned at the second position), it is possible to selectively use the pen holding portions on two locations without removing and inserting the pen tool 17.

In the cutting plotter 11 according to this embodiment, there are a first pen receiving portion 22 for the full-cut, constituted by a groove extending in the horizontal direction, and a second pen receiving portion 23 for the half-cut and writing, constituted by a surface extending in the horizontal direction, on the stage 13, spaced apart in the conveyance direction of the sheet 12. In this embodiment, the first position where the pen tool 17 is attached is located above the first pen receiving portion 22, and the second position is located above the second pen receiving portion 23. Therefore, it is possible to provide a cutting plotter that can easily switch between a mode for performing full-cut and a mode for performing half-cut or drawing.

### Engaging Structure

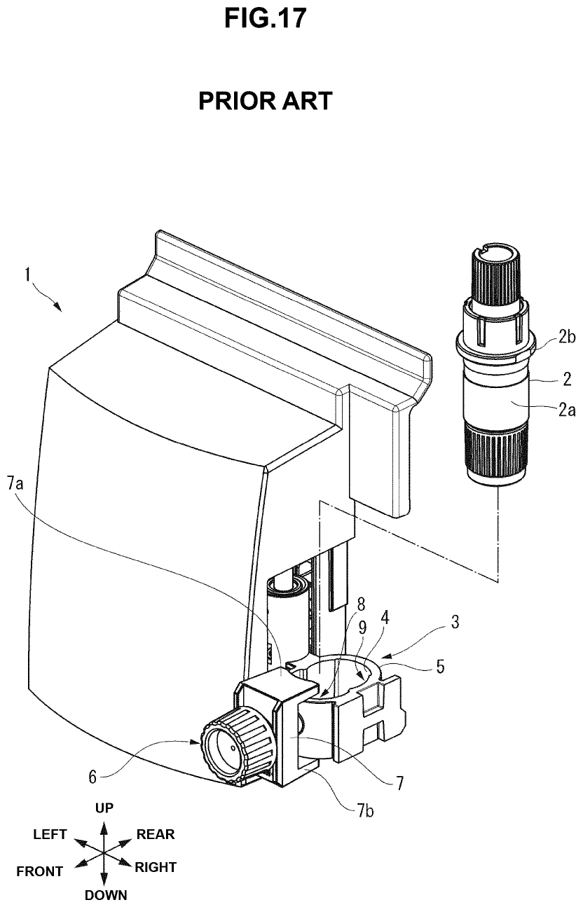

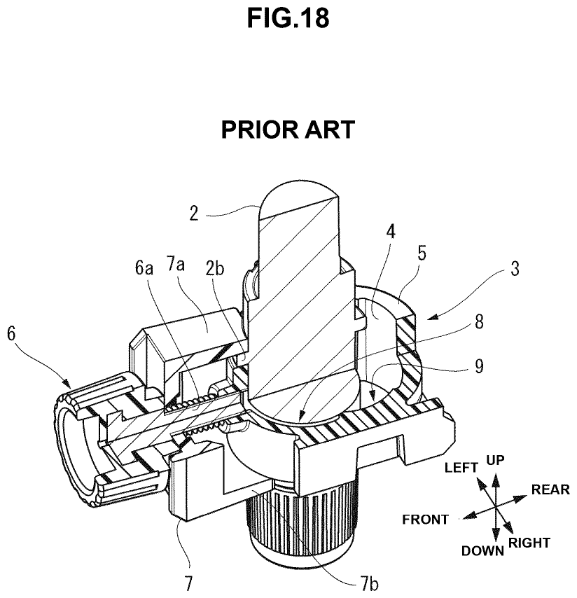

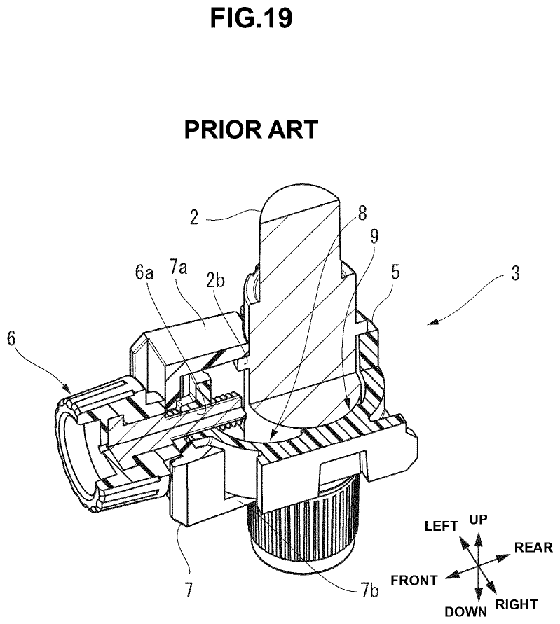

With respect to the conventional tool holder 3 shown in FIGS. 17-19, the following issues have also been pointed out regarding the structure for fixing the cutting pen 2 to the tool holder 3.

The first issue is that, when attaching the cutting pen 2 to the front pen holding portion 8, the threading amount of the screw member 6 is small, and therefore the screw member 6 tends to fall out of the main body 5 easily. This issue can be solved by lengthening the external thread 6a but adopting such a configuration makes the pen carriage 1 larger.

The second issue is that, when attaching the cutting pen 2 to the rear pen holding portion 9, the number of times the screw member 6 is rotated is large, making the work troublesome and the working time longer.

The third issue is that, when the cutting pen 2 is fixed to the front pen holding portion 8 or the rear pen holding portion 9, the direction of the reaction force acting on the screw member 6 coincides with the longitudinal direction of the screw member 6. Accordingly, the screw member 6 is likely to loosen due to the reaction force, and the reliability in maintaining the holding force for holding the cutting pen 2 is low.

The fourth issue is that mistakes may be made in positions of the flange 2b of the cutting pen 2 and the upper protrusion 7a of the tool fastener 7, in the up-down direction. That is, there are cases where the screw member 6 is tightened while the upper protrusion 7a overlaps above the flange 2b. In such cases, the cutting pen 2 may be disconnected by moving upwards out of the main body 5 during full-cut or half-cut.

With respect to these issues, the cutting plotter 11 according to this embodiment can provide a cutting plotter that prevents parts from falling off, improves operability and prevents incorrect installation, enhances holding force, etc., regarding the fixing structure of the pen tool 19 including the cutting pen 17.

In the cutting plotter 11 according to this embodiment, the upper pressing fragment 42 has a protrusion 50 that overlaps the flange 29 of the pen tool 17 from above while the pen tool 17 is pressed against the front inner wall surface 30 or the rear inner wall surface 31, as shown in FIGS. 10 and 11. As a result of the protrusion 50 overlapping the flange 29 placed on the recessed portion 28, the flange 29 is sandwiched by the recessed portion 28 and the protrusion 50 in the up-down direction, disabling the movement in the up-down direction. That is, the supporting member 25 and the sliding member 26 are provided with an engaging structure 51 that engages with the pen tool 17 to restrict up-down movement relative to the supporting member 25 of the pen tool 17 while the pen tool 17 is pressed against the front end or rear end of the through hole 24.

In this embodiment, the upper pressing fragment 42 of the sliding member 26 is arranged above the supporting member 25, and the lower pressing fragment 43 of the sliding member 26 is arranged below the supporting member 25. Accordingly, it is possible to apply a pressing force to parts of the pen tool 17 higher or lower than the supporting member 25, and therefore it is possible to perform cutting and drawing with high precision without the pen tool 17 being inclined.

In the cutting plotter 11 according to this embodiment, the pressing mechanism 27 includes: a presser 52 attached to the supporting member 25 by the screw member 36; and a front pressure receiving surface 62 and a rear pressure receiving surface 63 formed on the sliding member 26 so as to face the presser 52. The presser 52 and the front and rear pressure receiving surfaces 62 and 63 constitute a cam 64 for converting the pressing force applied from the presser 52 to the front pressure receiving surface 62 or the rear pressure receiving surface 63 into a driving force that moves the sliding member 26 in the front-rear direction.

Therefore, compared to a conventional configuration where the direction of advancement of the screw member is the same as the direction in which the pen tool is pressed against the pen holding portion, the direction (front-rear direction) of the reaction force acting on the presser 52 during pressing is perpendicular to the axial direction (left-right direction) of the screw member 36, making it harder for the screw member 36 to loosen. Moreover, according to this embodiment, the amount of rotation of the screw member 36 is approximately the same between the case where the pen tool 17 is attached on the first position and the case where the pen tool 17 is attached on the second position.

Thus, compared to adopting a conventional structure, it is possible to provide a cutting plotter that has improved performance in terms of preventing parts from falling off, operability, and holding force.

In the cutting plotter 11 according to this embodiment, the pressing mechanism 27 is constituted by a protrusion 45 of the sliding member 26 having the front and rear pressure receiving surfaces 62 and 63, and the presser 52 attached to the supporting member 25 by the screw member 36. However, the present invention is not limited to such a configuration. For example, it is also possible to employ a so-called rotary cam, which moves the sliding member 26 in the front-rear direction by a rotor rotatably attached to the supporting member.

In the cutting plotter 11 according to this embodiment, the engaging structure 51 is constituted by: a recessed portion 28 which is formed on an upper portion of the opening on the through hole 24 of the supporting member 25 such that a flange 29 of the pen tool 17 is placed thereon; and protrusions 50 formed on the front and rear ends of the upper pressing fragment 42 of the sliding member 26 so as to overlap the flange 29 from above.

Therefore, when attaching the pen tool 17 to the first position or the second position, the flange 29 of the pen tool 17 is always positioned below the protrusions 50 of the upper pressing fragment 42, thereby ensuring reliable prevention of incorrect attachment of the pen tool 17.

In the above-described embodiment, an example is shown where the first pen receiving portion 22 is positioned on the front side of the second pen receiving portion 23. However, the present invention can also be applied to cases where the second pen receiving portion 23 is provided on the front side of the first pen receiving portion 22. In this case, a writing tool is attached to the first position above the second pen receiving portion 23.

As described above, the cutting plotter according to this embodiment allows to selectively use the two pen holding portions without removing and inserting the cutting pen.

With respect to the fixing structure of the pen tool 19, it is possible to provide a cutting plotter that improves performance by, for example, preventing parts from falling off, improving operability and preventing incorrect installation, and enhancing holding power.

The embodiment of the present invention has been described above. However, the present invention is not limited to the above embodiment. Various modifications, as can be understood by those skilled in the art, can be made to the configuration and details of the present invention within the scope of the invention.

### APPENDICES

The following Appendices are also disclosed in relation to the above-described embodiment:

### Appendix 1

A cutting plotter comprising:
a stage (13) configured to support a medium-to-be-cut (12);
a conveyance mechanism (14) configured to convey a medium-to-be-cut placed on the stage along a surface of the stage in a first bidirectional direction;
a guide rail (16a) which is spaced apart from the surface of the stage and which extends in a second bidirectional direction parallel to the surface of the stage and intersecting with the first bidirectional direction;
a pen carriage (16) configured to move along the guide rail above the stage; and
a tool holder (21) which is supported by the pen carriage movable in a third bidirectional direction perpendicular to the first bidirectional direction and the second bidirectional direction and which holds a pen tool in a posture in which the pen tool extends in the third bidirectional direction, wherein the tool holder (21) comprises:
a supporting member (25) having a through hole (24) into which the pen tool is to be inserted;
a sliding member (26) supported by the supporting member movably along the first bidirectional direction; and
a pressing mechanism (45, 52, 36) configured to selectively bias the sliding member in either direction along the first bidirectional direction relative to the supporting member,
the through hole (24) has an oblong shape extending longer along the first bidirectional direction when viewed from the third bidirectional direction such that the pen tool is movable in the through hole from one end to the other along the first bidirectional direction, and the sliding member (26) comprises:
a first pressing portion (46, 47) for pressing the pen tool onto one side, in the first bidirectional direction, of an inner wall on the through hole by moving the pen tool in one direction along the first bidirectional direction relative to the supporting member; and
a second pressing portion (48, 49) for pressing the pen tool onto the other side, in the first bidirectional direction, of the inner wall on the through hole by moving the pen tool in the other direction along the first bidirectional direction relative to the supporting member.

### Appendix 2

The cutting plotter according to Appendix 1, wherein
the first pressing portion (46, 47) and the second pressing portion (48, 49) of the sliding member are provided on one side and the other side, in the third bidirectional direction, of the supporting member, respectively.

### Appendix 3

The cutting plotter according to Appendix 1 or 2, wherein
the pressing mechanism (45, 52, 36) includes:
a pressure receiving surface (62, 63) formed on the sliding member;
a presser (52) arranged to face the pressure receiving surface; and
a screw member (36) for attaching the presser to the supporting member,
the pressure receiving surface (62, 63) and the presser (52) constitutes a cam for converting a pressure force along the second bidirectional direction applied to the pressure receiving surface from the presser by the screw member (36) into a driving force that moves the sliding member (26) along the first bidirectional direction.

### Appendix 4

The cutting plotter according to any one of Appendices 1-3, wherein
the supporting member (25) and the sliding member (26) includes an engaging structure (28, 29, 51) for restricting movement of the pen tool in the second bidirectional direction relative to the supporting member by engaging with the pen tool (19) while the pen tool (19) is pressed onto the one side (30) and the other side (31), in the first bidirectional direction, of the inner wall on the through hole (24), respectively.

### Appendix 5

The cutting plotter according to Appendix 4, wherein
the engaging structure (28, 29, 51) is constituted by:
a recessed portion (28) which is formed on a peripheral edge of an opening on the through hole on an upper side of the supporting member and on which a flange (29) is placed on an outer circumference of the pen tool; and
a protrusion (51) which is arranged on the first pressing portion and the second pressing portion of the sliding member such that the flange (29) is sandwiched between the protrusion and a top surface of the recessed portion on the supporting member.

### Appendix 6

The cutting plotter according to any one of Appendices 1-5, wherein
the stage (13) includes a first pen receiving portion (22) for the full-cut constituted by a groove extending along the second bidirectional direction, and a second pen receiving portion (23) for the half-cut and writing constituted by a surface extending along the second bidirectional direction,
the first pen receiving portion and the second pen receiving portion are arranged spaced apart from each other in the first bidirectional direction, and
when a position of the pen tool pressed against the one side (30), in the first bidirectional direction, of the inner wall on the through hole is a first position, and a position of the pen tool pressed against the other side (31), in the first bidirectional direction, of the inner wall on the through hole is a second position, the first position is located above either one of the first pen receiving portion and the second pen receiving portion and the second position is located above the other one of the first pen receiving portion and the second pen receiving portion.

### REFERENCE SIGNS LIST

11 . . . cutting plotter, 12 . . . sheet, 13 . . . stage, 16 . . . pen carriage, 17 . . . pen tool, 21 . . . tool holder, 22 . . . first pen receiving portion, 23 . . . second pen receiving portion, 24 . . . through hole, 25 . . . supporting member, 26 . . . slide member, 27 . . . pressing mechanism, 28 . . . recessed portion, 29 . . . flange, 36 . . . screw member, 46 . . . rear end of upper pressing fragment (first pressing portion), 47 . . . rear end of lower pressing fragment (first pressing portion), 48 . . . front end of upper pressing fragment (second pressing portion), 49 . . . front end of lower pressing fragment (second pressing portion), 51 . . . engaging structure, 52 . . . presser, 62 . . . front pressure receiving surface, 63 . . . rear pressure receiving surface, 64 . . . cam, 50 . . . protrusion

1. A cutting plotter comprising:
a stage configured to support a medium-to-be-cut;
a conveyance mechanism configured to convey a medium-to-be-cut placed on the stage along a surface of the stage in a first bidirectional direction;
a guide rail which is spaced apart from the surface of the stage and which extends in a second bidirectional direction parallel to the surface of the stage and intersecting with the first bidirectional direction;
a pen carriage configured to move along the guide rail above the stage; and
a tool holder which is supported by the pen carriage movable in a third bidirectional direction perpendicular to the first bidirectional direction and the second bidirectional direction and which holds a pen tool in a posture in which the pen tool extends in the third bidirectional direction, wherein the tool holder comprises:
a supporting member having a through hole into which the pen tool is to be inserted;
a sliding member supported by the supporting member movably along the first bidirectional direction; and
a pressing mechanism configured to selectively bias the sliding member in either direction along the first bidirectional direction relative to the supporting member,
the through hole has an oblong shape extending longer along the first bidirectional direction when viewed from the third bidirectional direction such that the pen tool is movable in the through hole from one end to the other along the first bidirectional direction, and
the sliding member comprises:
a first pressing portion for pressing the pen tool onto one side, in the first bidirectional direction, of an inner wall on the through hole by moving the pen tool in one direction along the first bidirectional direction relative to the supporting member; and
a second pressing portion for pressing the pen tool onto the other side, in the first bidirectional direction, of the inner wall on the through hole by moving the pen tool in the other direction along the first bidirectional direction relative to the supporting member.

2. The cutting plotter according to claim 1, wherein
the first pressing portion and the second pressing portion of the sliding member are provided on one side and the other side, in the third bidirectional direction, of the supporting member, respectively.

3. The cutting plotter according to claim 1, wherein
the pressing mechanism includes:
a pressure receiving surface formed on the sliding member;
a presser arranged to face the pressure receiving surface; and
a screw member for attaching the presser to the supporting member,
the pressure receiving surface and the presser constitutes a cam for converting a pressure force along the second bidirectional direction applied to the pressure receiving surface from the presser by the screw member into a driving force that moves the sliding member along the first bidirectional direction.

4. The cutting plotter according to claim 1, wherein
the supporting member and the sliding member includes an engaging structure for restricting movement of the pen tool in the second bidirectional direction relative to the supporting member by engaging with the pen tool while the pen tool is pressed onto the one side and the other side, in the first bidirectional direction, of the inner wall on the through hole, respectively.

5. The cutting plotter according to claim 4, wherein
the engaging structure is constituted by:
a recessed portion which is formed on a peripheral edge of an opening on the through hole on an upper side of the supporting member and on which a flange is placed on an outer circumference of the pen tool; and
a protrusion which is arranged on the first pressing portion and the second pressing portion of the sliding member such that the flange is sandwiched between the protrusion and a top surface of the recessed portion on the supporting member.

6. The cutting plotter according to claim 1, wherein
the stage includes a first pen receiving portion for the full-cut constituted by a groove extending along the second bidirectional direction, and a second pen receiving portion for the half-cut and writing constituted by a surface extending along the second bidirectional direction,
the first pen receiving portion and the second pen receiving portion are arranged spaced apart from each other in the first bidirectional direction, and
when a position of the pen tool pressed against the one side, in the first bidirectional direction, of the inner wall on the through hole is a first position, and a position of the pen tool pressed against the other side, in the first bidirectional direction, of the inner wall on the through hole is a second position, the first position is located above either one of the first pen receiving portion and the second pen receiving portion and the second position is located above the other one of the first pen receiving portion and the second pen receiving portion.

7. The cutting plotter according to claim 2, wherein
the pressing mechanism includes:
a pressure receiving surface formed on the sliding member;
a presser arranged to face the pressure receiving surface; and
a screw member for attaching the presser to the supporting member,
the pressure receiving surface and the presser constitutes a cam for converting a pressure force along the second bidirectional direction applied to the pressure receiving surface from the presser by the screw member into a driving force that moves the sliding member along the first bidirectional direction.

8. The cutting plotter according to claim 2, wherein
the supporting member and the sliding member includes an engaging structure for restricting movement of the pen tool in the second bidirectional direction relative to the supporting member by engaging with the pen tool while the pen tool is pressed onto the one side and the other side, in the first bidirectional direction, of the inner wall on the through hole, respectively.

9. The cutting plotter according to claim 8, wherein
the engaging structure is constituted by:
a recessed portion which is formed on a peripheral edge of an opening on the through hole on an upper side of the supporting member and on which a flange is placed on an outer circumference of the pen tool; and
a protrusion which is arranged on the first pressing portion and the second pressing portion of the sliding member such that the flange is sandwiched between the protrusion and a top surface of the recessed portion on the supporting member.

10. The cutting plotter according to claim 2, wherein
the stage includes a first pen receiving portion for the full-cut constituted by a groove extending along the second bidirectional direction, and a second pen receiving portion for the half-cut and writing constituted by a surface extending along the second bidirectional direction,
the first pen receiving portion and the second pen receiving portion are arranged spaced apart from each other in the first bidirectional direction, and
when a position of the pen tool pressed against the one side, in the first bidirectional direction, of the inner wall on the through hole is a first position, and a position of the pen tool pressed against the other side, in the first bidirectional direction, of the inner wall on the through hole is a second position, the first position is located above either one of the first pen receiving portion and the second pen receiving portion and the second position is located above the other one of the first pen receiving portion and the second pen receiving portion.

11. The cutting plotter according to claim 3, wherein
the supporting member and the sliding member includes an engaging structure for restricting movement of the pen tool in the second bidirectional direction relative to the supporting member by engaging with the pen tool while the pen tool is pressed onto the one side and the other side, in the first bidirectional direction, of the inner wall on the through hole, respectively.

12. The cutting plotter according to claim 11, wherein
the engaging structure is constituted by:
a recessed portion which is formed on a peripheral edge of an opening on the through hole on an upper side of the supporting member and on which a flange is placed on an outer circumference of the pen tool; and
a protrusion which is arranged on the first pressing portion and the second pressing portion of the sliding member such that the flange is sandwiched between the protrusion and a top surface of the recessed portion on the supporting member.

13. The cutting plotter according to claim 3, wherein
the stage includes a first pen receiving portion for the full-cut constituted by a groove extending along the second bidirectional direction, and a second pen receiving portion for the half-cut and writing constituted by a surface extending along the second bidirectional direction,
the first pen receiving portion and the second pen receiving portion are arranged spaced apart from each other in the first bidirectional direction, and
when a position of the pen tool pressed against the one side, in the first bidirectional direction, of the inner wall on the through hole is a first position, and a position of the pen tool pressed against the other side, in the first bidirectional direction, of the inner wall on the through hole is a second position, the first position is located above either one of the first pen receiving portion and the second pen receiving portion and the second position is located above the other one of the first pen receiving portion and the second pen receiving portion.

14. The cutting plotter according to claim 4, wherein
the stage includes a first pen receiving portion for the full-cut constituted by a groove extending along the second bidirectional direction, and a second pen receiving portion for the half-cut and writing constituted by a surface extending along the second bidirectional direction,
the first pen receiving portion and the second pen receiving portion are arranged spaced apart from each other in the first bidirectional direction, and
when a position of the pen tool pressed against the one side, in the first bidirectional direction, of the inner wall on the through hole is a first position, and a position of the pen tool pressed against the other side, in the first bidirectional direction, of the inner wall on the through hole is a second position, the first position is located above either one of the first pen receiving portion and the second pen receiving portion and the second position is located above the other one of the first pen receiving portion and the second pen receiving portion.

15. The cutting plotter according to claim 5, wherein
the stage includes a first pen receiving portion for the full-cut constituted by a groove extending along the second bidirectional direction, and a second pen receiving portion for the half-cut and writing constituted by a surface extending along the second bidirectional direction,
the first pen receiving portion and the second pen receiving portion are arranged spaced apart from each other in the first bidirectional direction, and
when a position of the pen tool pressed against the one side, in the first bidirectional direction, of the inner wall on the through hole is a first position, and a position of the pen tool pressed against the other side, in the first bidirectional direction, of the inner wall on the through hole is a second position, the first position is located above either one of the first pen receiving portion and the second pen receiving portion and the second position is located above the other one of the first pen receiving portion and the second pen receiving portion.

16. The cutting plotter according to claim 9, wherein
the stage includes a first pen receiving portion for the full-cut constituted by a groove extending along the second bidirectional direction, and a second pen receiving portion for the half-cut and writing constituted by a surface extending along the second bidirectional direction,
the first pen receiving portion and the second pen receiving portion are arranged spaced apart from each other in the first bidirectional direction, and
when a position of the pen tool pressed against the one side, in the first bidirectional direction, of the inner wall on the through hole is a first position, and a position of the pen tool pressed against the other side, in the first bidirectional direction, of the inner wall on the through hole is a second position, the first position is located above either one of the first pen receiving portion and the second pen receiving portion and the second position is located above the other one of the first pen receiving portion and the second pen receiving portion.

17. The cutting plotter according to claim 8, wherein
the stage includes a first pen receiving portion for the full-cut constituted by a groove extending along the second bidirectional direction, and a second pen receiving portion for the half-cut and writing constituted by a surface extending along the second bidirectional direction,
the first pen receiving portion and the second pen receiving portion are arranged spaced apart from each other in the first bidirectional direction, and
when a position of the pen tool pressed against the one side, in the first bidirectional direction, of the inner wall on the through hole is a first position, and a position of the pen tool pressed against the other side, in the first bidirectional direction, of the inner wall on the through hole is a second position, the first position is located above either one of the first pen receiving portion and the second pen receiving portion and the second position is located above the other one of the first pen receiving portion and the second pen receiving portion.

18. The cutting plotter according to claim 12, wherein
the stage includes a first pen receiving portion for the full-cut constituted by a groove extending along the second bidirectional direction, and a second pen receiving portion for the half-cut and writing constituted by a surface extending along the second bidirectional direction,
the first pen receiving portion and the second pen receiving portion are arranged spaced apart from each other in the first bidirectional direction, and
when a position of the pen tool pressed against the one side, in the first bidirectional direction, of the inner wall on the through hole is a first position, and a position of the pen tool pressed against the other side, in the first bidirectional direction, of the inner wall on the through hole is a second position, the first position is located above either one of the first pen receiving portion and the second pen receiving portion and the second position is located above the other one of the first pen receiving portion and the second pen receiving portion.

19. The cutting plotter according to claim 11, wherein
the stage includes a first pen receiving portion for the full-cut constituted by a groove extending along the second bidirectional direction, and a second pen receiving portion for the half-cut and writing constituted by a surface extending along the second bidirectional direction,
the first pen receiving portion and the second pen receiving portion are arranged spaced apart from each other in the first bidirectional direction, and
when a position of the pen tool pressed against the one side, in the first bidirectional direction, of the inner wall on the through hole is a first position, and a position of the pen tool pressed against the other side, in the first bidirectional direction, of the inner wall on the through hole is a second position, the first position is located above either one of the first pen receiving portion and the second pen receiving portion and the second position is located above the other one of the first pen receiving portion and the second pen receiving portion.
